(19) United States
(12) Patent Application Publication
(10) Pub. No.: US 2021/0141222 A1
(43) Pub. Date: May 13, 2021

(54) DEVICE FOR PRODUCING A VIRTUAL IMAGE HAVING A FIELD-POINT-DEPENDENT APERTURE

(71) Applicant: CONTINENTAL AUTOMOTIVE GMBH, Hannover (DE)

(72) Inventor: Wolff von Spiegel, Bad Homburg (DE)

(73) Assignee: CONTINENTAL AUTOMOTIVE GMBH, Hannover (DE)

(21) Appl. No.: 17/122,186

(22) Filed: Dec. 15, 2020

Related U.S. Application Data
(63) Continuation of application No. PCT/EP2019/065584, filed on Jun. 13, 2019.

(30) Foreign Application Priority Data
Jun. 15, 2018 (DE) 10 2018 209 650.3
Aug. 7, 2018 (DE) 10 2018 213 205.4

(51) Int. Cl. G02B 27/01; F21V 8/00; B60K 35/00

(52) U.S. Cl. CPC G02B 27/0101; G02B 6/0023; G02B 27/0103; B60K 2370/1529; B60K 35/00; G02B 2027/0123; G02B 2027/0105; G02B 6/0076

(57) ABSTRACT

The invention relates to a device for generating a virtual image with scanning image production. The device has at least one light source for producing a light beam, an image-generating unit for producing an image, and an optical waveguide for expanding an exit pupil. The optical waveguide has an input coupling hologram. With the imaging unit in connection with the input coupling hologram, a field-point-dependent aperture for the optical waveguide is implemented.

### CROSS-REFERENCE TO RELATED APPLICATIONS

This application claims priority to PCT Application PCT/EP2019/065584, filed Jun. 13, 2019, which claims priority to German Patent Application No. DE 10 2018 209 650.3, filed Jun. 15, 2018 and German Patent Application No. DE 10 2018 213 205.4, filed Aug. 7, 2018. The disclosures of the above applications are incorporated herein by reference.

### FIELD OF THE INVENTION

The present invention relates to a device for generating a virtual image.

### BACKGROUND OF THE INVENTION

A head-up display, also referred to as a HUD, is understood to refer to a display system in which the viewer may maintain their viewing direction, since the contents to be represented are superposed into their field of view. While such systems were originally primarily used in the aerospace sector due to their complexity and cost, they are now also being used in large-scale production in the automotive sector.

Head-up displays generally consist of an image generator, an optics unit, and a mirror unit. The image generator produces the image. The optics unit directs the image onto the mirror unit. The image generator is often also referred to as an image-generating unit or PGU (Picture Generating Unit). The mirror unit is a partially reflective, light-transmissive pane. The viewer thus sees the contents represented by the image generator as a virtual image and at the same time sees the real world behind the pane. In the automotive sector, the windshield is often used as the mirror unit, and the curved shape of the windshield must be taken into account in the representation. Due to the interaction of the optics unit and the mirror unit, the virtual image is an enlarged representation of the image produced by the image generator.

The viewer may view the virtual image only from the position of what is known as the eyebox. A region whose height and width correspond to a theoretical viewing window is called an eyebox. As long as one eye of the viewer is within the eyebox, all elements of the virtual image are visible to that eye. If, on the other hand, the eye is outside the eyebox, the virtual image is only partially visible to the viewer, or not at all. The larger the eyebox is, the less restricted the viewer is in choosing their seating position.

The size of the eyebox of conventional head-up displays is limited by the size of the optics unit. One approach for enlarging the eyebox is to couple the light coming from the image-generating unit into an optical waveguide. The light that is coupled into the optical waveguide undergoes total internal reflection at the interfaces thereof and is thus guided within the optical waveguide. In addition, a portion of the light is coupled out at a multiplicity of positions along the propagation direction. Owing to the optical waveguide, the exit pupil is in this way expanded. The effective exit pupil is composed here of images of the aperture of the image generation system.

Against this background, US 2016/0124223 A1 describes a display apparatus for virtual images. The display apparatus includes an optical waveguide that causes light that is coming from an image-generating unit and is incident through a first light incidence surface to repeatedly undergo internal reflection in order to move in a first direction away from the first light incidence surface. The optical waveguide also has the effect that a portion of the light guided in the optical waveguide exits to the outside through regions of a first light exit surface that extends in the first direction. The display apparatus further includes a first light-incidence-side diffraction grating that diffracts incident light to cause the diffracted light to enter the optical waveguide, and a first light-emergent diffraction grating that diffracts the light that is incident from the optical waveguide.

A typical image-generating device for head-up displays with holographic optical waveguides has a scanning projector with LED-based light sources. The spectral width and the large number of beam angles ensure good aperture coverage in LED-based systems. Such systems are therefore not very susceptible to interference effects, such as what is known as banding.

To increase the efficiency and for functionally expanding head-up displays with a holographic optical waveguide, it makes sense to use lasers as light sources instead of LEDs. However, the use of lasers as the light sources has the disadvantage that the systems are significantly less tolerant. The exit aperture must be assembled cleanly in order to avoid disruptive effects. Complex systems are currently being used to implement a variable aperture for uniformly filled composed apertures. These systems consist of different components and are complex to design. Each component is associated with tolerances and a loss of light. The systems additionally require some of the already limited installation space and increase both the weight and the costs of the head-up display.

### SUMMARY OF THE INVENTION

It is an object of the present invention to propose an improved device for generating a virtual image in which a field-point-dependent aperture is implemented in a simple manner.

This object is achieved by a device having the features described. Preferred configurations of the invention are also described.

According to a first aspect of the invention, a device for generating a virtual image has:
at least one light source for producing a light beam;
   an image-generating unit for producing an image; and
   an optical waveguide for expanding an exit pupil, wherein the optical waveguide has an input coupling hologram;
and wherein, with the image-generating unit in connection with the input coupling hologram, a field-point-dependent aperture for the optical waveguide is implemented.

In order to implement the field-point-dependent aperture, light beams emitted by the light source are prepared in such a way that the light beams are incident on a boundary surface of the optical waveguide at different angles in at least one spatial direction. There, an input coupling structure of the input coupling hologram ensures that the incident light is deflected at a propagation angle suitable for total internal reflection in the optical waveguide such that the propagation angle matches the desired aperture area, that is to say the reflection grid typically harmonizes in each case with the associated size of the aperture. The input coupling hologram thus combines input coupling and angle adjustment in one element.

With the solution according to the invention, a field-point-dependent aperture is attained without additional optical components. This makes it possible to implement an inexpensive, robust, and space-saving head-up display. The proposed system here allows the reduction in banding in the optical waveguide.

According to one aspect of the invention, a surface area illuminated by a light beam on the boundary surface of the optical waveguide increases monotonically over the total illuminated region of the boundary surface. For example, the monotonic increase here follows a cosine factor. If the light beam is imagined approximately as a cylinder that is cut through by the boundary surface of the optical waveguide, then the cut surface area is a circle at normal incidence. The larger the angle of incidence becomes, the wider the ellipse that then represents the cut surface area becomes. The width corresponds to the original diameter of the circle divided by the cosine of the angle of incidence. The illuminated surface area is therefore determined by the cosine of the angle of incidence.

According to one aspect of the invention, the input coupling hologram has an input coupling structure with a location-dependent grating constant. Using such a location-dependent grating constant, the desired field-point-dependent aperture or the angle adjustment may be realized in a simple manner. Since the grating constant changes over the surface area, undesirably coupling the light already guided by way of total internal reflection out again prematurely via the input coupling hologram also becomes more difficult. This results in a reduction in loss factors.

According to one aspect of the invention, the image-generating unit has a microscanner. The solution according to the invention harmonizes well with such a scanner, which in turn allows the implementation of a simple and compact image-generating unit. The microscanner may for example be a MEMS scanner (MEMS: microelectromechanical system; microsystem).

According to one aspect of the invention, the light source produces a non-collimated light beam, wherein the input coupling hologram compensates for the lack of collimation of the light beam. In this way, an additional optical component for collimating the light beam may be dispensed with. In addition, the use of a non-collimated light beam makes possible a larger and more targeted variation of the incidence surface area than the cosine factor mentioned above allows.

Alternatively, the light source produces a collimated light beam. For this purpose, the light source is preferably a laser.

A device according to the invention for generating a virtual image has at least one light source for producing a collimated light beam, an image-generating unit with a microscanner for producing an image, and an optical waveguide for expanding an exit pupil. The optical waveguide in this case has an input coupling hologram with an input coupling structure with a location-dependent grating constant. With the image-generating unit, in connection with the input coupling hologram, a field-point-dependent aperture for the optical waveguide is implemented in that light beams emanating from the microscanner are incident on the input coupling structure at different angles in at least one spatial direction. The location-independent grating constant of the input coupling structure serves for adapting the propagation angle to the desired aperture area. The solution given here is based on collimated light beams. A collimation of the light beams or a compensation of imaging aberrations is not effected by the input coupling structure.

A device according to the invention is preferably used in a vehicle, such as in a motor vehicle.

Further features of the present invention will become apparent from the following description in conjunction with the Figures.

Further advantages, features, and developments are gathered from the following examples, which will be explained in connection with the Figures. Identical elements or elements of the same type or with equivalent actions may be denoted by the same reference signs throughout the Figures.

### BRIEF DESCRIPTION OF THE DRAWINGS

FIG. 1 schematically shows a head-up display according to the prior art for a motor vehicle;

FIG. 2 shows an optical waveguide with two-dimensional enlargement;

FIG. 3 schematically shows a head-up display with an optical waveguide;

FIG. 4 schematically shows a head-up display with an optical waveguide in a motor vehicle;

FIG. 5 schematically shows a cross section of an optical waveguide of a head-up display according to the invention;

FIG. 6 schematically shows a perspective view of an optical waveguide of a head-up display according to the invention;

FIG. 7 schematically shows the course of a collimated beam bundle in an optical waveguide,

FIG. 8 shows this course for two different angles in comparison,

FIG. 9 shows an exemplary profile of the grating period over the angle of incidence;

FIG. 10 shows a cross section corresponding to FIG. 5; and

FIG. 11 shows an enlarged section of FIG. 10.

### DETAILED DESCRIPTION OF THE PREFERRED EMBODIMENTS

The following description of the preferred embodiment(s) is merely exemplary in nature and is in no way intended to limit the invention, its application, or uses.

For a better understanding of the principles of the present invention, embodiments of the invention will be explained in more detail below with reference to the Figures. The same reference signs will be used in the Figures for identical or functionally identical elements and are not necessarily described again for each Figure. It is to be understood that the invention is not restricted to the illustrated embodiments and that the features described may also be combined or modified without departing from the scope of protection of the invention as defined herein.

Initially, the basic concept of a head-up display with an optical waveguide will be explained with reference to FIGS. 1 to 4.

FIG. 1 shows a schematic diagram of a head-up display according to the prior art for a motor vehicle. The head-up display has an image generator 1, an optics unit 2, and a mirror unit 3. A beam bundle SB1 emanates from a display element 11 and is reflected by a folding mirror 21 onto a curved mirror 22 that reflects it in the direction of the mirror unit 3. The mirror unit 3 is illustrated here as a windshield 31 of a motor vehicle. From there, the beam bundle SB2 travels in the direction of an eye 61 of a viewer.

The viewer sees a virtual image VB that is located outside the motor vehicle above the engine hood or even in front of the motor vehicle. Due to the interaction of the optics unit 2 and the mirror unit 3, the virtual image VB is an enlarged representation of the image displayed by the display element 11. A speed limit, the current vehicle speed, and navigation instructions are symbolically represented here. As long as the eye 61 is located within the eyebox 62 indicated by a rectangle, all elements of the virtual image are visible to that eye 61. If the eye 61 is outside the eyebox 62, the virtual image VB is only partially visible to the viewer, or not at all. The larger the eyebox 62 is, the less restricted the viewer is when choosing their seating position.

The curvature of the curved mirror 22 serves to prepare the beam path and thus to ensure a larger image and a larger eyebox 62. In addition, the curvature compensates for a curvature of the windshield 31, with the result that the virtual image VB corresponds to an enlarged reproduction of the image represented by the display element 11. The curved mirror 22 is rotatably mounted by a bearing 221. The rotation of the curved mirror 22 that is made possible thereby makes it possible to displace the eyebox 62 and thus to adapt the position of the eyebox 62 to the position of the eye 61. The folding mirror 21 serves to ensure that the path traveled by the beam bundle SB1 between the display element 11 and the curved mirror 22 is long and, at the same time, that the optics unit 2 is nevertheless compact. The optics unit 2 is delimited with respect to the environment by a transparent cover 23. The optical elements of the optics unit 2 are thus protected for example against dust located in the interior of the vehicle. An optical film 24 or a coating that is intended to prevent incident sunlight SL from reaching the display element 11 via the mirrors 21, 22 is situated on the cover 23. The display element 11 could otherwise be temporarily or permanently damaged by the resulting development of heat. In order to prevent this, an infrared component of the sunlight SL is filtered out for example by the optical film 24. Anti-glare protection 25 serves to block incident light from the front so that it is not reflected by the cover 23 in the direction of the windshield 31, which could cause the viewer to be dazzled. In addition to the sunlight SL, the light from another stray light source 64 may also reach the display element 11.

FIG. 2 shows a schematic spatial illustration of an optical waveguide 5 with two-dimensional enlargement. In the lower left region, an input coupling hologram 53 is seen, by which light L1 coming from an image-generating unit (not shown) is coupled into the optical waveguide 5. The light spreads therein in the drawing to the top right, according to the arrow L2. In this region of the optical waveguide 5, a folding hologram 51 that acts similarly to many partially transmissive mirrors arranged one behind the other and produces a light bundle that is expanded in the Y-direction and propagates in the X-direction is located. This is indicated by three arrows L3. In the part of the optical waveguide 5 that extends to the right in the Figure, an output coupling hologram 52 is located, which likewise acts similarly to many partially transmissive mirrors arranged one behind the other and, indicated by arrows L4, couples light upward in the Z-direction out of the optical waveguide 5. In this case, an expansion takes place in the X-direction, so that the original incident light bundle L1 leaves the optical waveguide 5 as a light bundle L4 that is enlarged in two dimensions.

FIG. 3 shows a three-dimensional illustration of a head-up display with three optical waveguides 5R, 5G, 5B, which are arranged one above the other and each stand for an elementary color red, green, and blue. Together they form the optical waveguide 5. The holograms 51, 52, 53 present in the optical waveguide 5 are each wavelength-dependent, meaning that one optical waveguide 5R, 5G, 5B is used in each case for one of the elementary colors. An image generator 1 and an optics unit 2 are shown above the optical waveguide 5. The optics unit 2 has a mirror 20, by which the light produced by the image generator 1 and shaped by the optics unit 2 is deflected in the direction of the respective input coupling hologram 53. The image generator 1 has three light sources 14R, 14G, 14B for the three elementary colors. It is seen that the entire unit shown has a small overall structural height compared to its light-emitting surface.

FIG. 4 shows a head-up display in a motor vehicle similar to FIG. 1, except here in a three-dimensional illustration and with an optical waveguide 5. It shows the schematically indicated image generator 1, which produces a parallel beam bundle SB1 that is coupled into the optical waveguide 5 by the mirror plane 523. The optics unit is not shown for the sake of simplicity. A plurality of mirror planes 522 each reflect a portion of the light incident on them in the direction of the windshield 31, the mirror unit 3. The light is reflected thereby in the direction of the eye 61. The viewer sees a virtual image VB above the engine hood or at an even farther distance in front of the motor vehicle.

FIG. 5 schematically shows a cross section of an optical waveguide 5 of a head-up display according to the invention. It shows two approximately collimated light beams L1_1, L1_2 emanating from the image-generating unit 1 for image production. The light beams L1_1, L1_2 are prepared in such a way that the light beams L1_1, L1_2 are incident on a boundary surface 502 of the optical waveguide 5 at different angles in at least one spatial direction. In FIG. 5, this is the lower boundary surface 502 of the optical waveguide 5. The angles of incidence of the light beams L1_1, L1_2 are selected such that the surface area illuminated by the light beams L1_1, L1_2 continuously increases monotonically over the region BB of the boundary surface 502 that is illuminated overall by the light beams L1_1, L1_2. In FIG. 5, the light beam L1_1 is incident on the boundary surface 502 perpendicularly, that is to say the angle of incidence is 0°. In this case, the illuminated surface area is a circle with a diameter B. The light beam L1_2 is incident on the boundary surface 502 at an angle of incidence that differs from 0°. The illuminated surface area therefore has the shape of an ellipse. The larger the angle of incidence becomes, the wider the ellipse becomes. The width corresponds to the original diameter of the circle divided by the cosine of the angle of incidence, i.e. the increase follows a cosine factor.

An input coupling structure 532 of the input coupling hologram now ensures that the incident light beams L1_1, L1_2 are deflected at a propagation angle suitable for total internal reflection at the lower boundary surface 502 and an upper boundary surface 501 in the optical waveguide 5. The input coupling structure 532 is designed here in such a way that the propagation angle matches the desired aperture area, that is to say that the reflection grid typically harmonizes in each case with the associated size of the aperture. The input coupling hologram thus combines input coupling and angle adjustment in one element. For the angle adjustment, the input coupling structure 532 preferably has a location-dependent grating constant. Since the grating constant changes over the surface area, undesirably coupling the light L1_1, L1_2 already guided by way of total internal reflection out again prematurely via the input coupling hologram also becomes more difficult. This results in a reduction in loss factors.

FIG. 6 schematically shows a perspective view of an optical waveguide 5 of a head-up display according to the invention. It shows that the light beams L1_1, L1_2 coupled into the optical waveguide 5 at different angles fill different specific apertures A1, A2.

FIG. 7 schematically shows the course of a collimated beam bundle in an optical waveguide. In the head-up display described, the aim is usually a representation of a virtual image far (measured in meters) behind the exit aperture of the head-up display described. The representation preferably lies above the radiator of a motor vehicle at the front of the vehicle or—especially for augmented reality applications—farther in front of the vehicle. One way of realizing special features of image input coupling is explained with reference to FIG. 7. In the case of a head-up display with optical waveguide technology, a pixel on the image-generating device (image point a) is translated into a collimated beam bundle with the projected width b (aperture) and the angle a by the optical unit of the image-generating unit 1. If the eye 61 of the viewer is located in the output coupling region, the depicted point a′ corresponding to a is formed in the eye of the viewer in the case of accommodation at a distance. The aperture of the optical unit of the image-generating unit 1 is replicated multiple times by reflections during the propagation of the light by way of total internal reflection and by step-by-step output coupling through the grating. The period g with which the output couplings are repeated depends here on the glass thickness d and the angle at which the bundle propagates in the waveguide. It is one aim of the invention to achieve the most uniform illumination possible of the exit aperture by stringing together reflections of the aperture of the optical unit of the image-generating unit 1 in order to avoid image reproduction errors such as stripes. For this purpose, the gap z=g−b should be controlled, i.e. eliminated in the simplest example (z=0). In this case, the aim is b=g.

The period g depends on the field point via the propagation angle in the optical waveguide 5. In the invention, the propagation angle is set via the input coupling grating in such a way that the period g associated therewith corresponds to the projected width b. The propagation angle is controlled in this case via the grating period. FIG. 8 shows the course of a collimated light bundle for two different angles a in comparison, on the left for a larger angle than on the right.

To simplify the view, refraction at the interfaces of the optical waveguide 5 is neglected in the following example, and the focus is on the processes taking place at the grating. If an image field of 10° is to be covered at an average angle of incidence of 45° of the collimated light bundle (3 diameter) of the image-generating unit 1 (green, wavelength 550 nm), the resulting angles of incidence are 40°, 45°, 50° for the center and margins of the field on the optical waveguide 5 (thickness of 2.7 mm). The corresponding horizontal components of the wavenumber of the incident light are 8.75 M/m, 8.08 M/m, 7.34 M/m and the projected bundle widths are 3.9 mm, 4.2 mm and 4.7 mm. The appropriate propagation angles in the optical waveguide 5 are 46.4877°, 51.7831° and 59.8018°. These include the horizontal wavenumber components 7.87 M/m, 7.07 M/m and 5.75 M/m, from which the differences 0.89 M/m, 1.01 M/m and 1.60 M/m result, which corresponds to the following grating periods: 7.094 μm, 6.217 μm and 3.934 μm. In this example, a period of 7.094 μm is required at the point where the beam is incident at an angle of 40°, whereas a period of 3.934 μm is required at the point where the beam is incident at below 50°. FIG. 9 shows the profile of the grating period over the angle of incidence in this example.

FIG. 10 shows a schematic cross section corresponding to FIG. 5. Here, additional light beams L1(40), L1(45) and L1(50) corresponding to the angles α=40°, α=45°, and α=50° are drawn in the region of the light beams L1_2. They are incident at slightly offset points in the illuminated region BB. The mark M9 shows the part of the illuminated region BB on which the light beams L1(40), L1(45) and L1(50) are incident. This part is shown enlarged in the following Figure. In practice, there will generally not be a broad angular distribution ranging from 0° to 45°, as previously described schematically, but rather narrower angular distributions such as the 40°-50° shown here. For the sake of clarity, the further courses of the light beams L1(40) and L1(50) in the optical waveguide 5 are not shown here. It should be noted that the light beams L1_1, L1_2, L1(40), L1(45) and L1(50) each form extended groups of light beams. These groups are also known as light bundles. These light bundles have a specific width.

FIG. 11 shows in its lower part the part of the schematic cross section from FIG. 10 with the mark M9. The grating structure is shown schematically in the top part of the Figure in plan view CC. It is seen that the period g decreases from left to right. The period g(40) is optimized for the angle of the light beams L1(40), the period g(45) for that of the light beams L1(45), the period g(50) for that of the light beams L1(50).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device for generating a virtual image, comprising:
at least one light source for producing a light beam;
an image-generating unit for producing an image; and
an optical waveguide for expanding an exit pupil, wherein the optical waveguide has an input coupling hologram;
wherein, with the image-generating unit in connection with the input coupling hologram, a field-point-dependent aperture for the optical waveguide is implemented.

2. The device of claim 1, the optical waveguide further comprising a boundary surface, wherein light beams emitted by the light source are prepared in such a way that the light beams are incident on the boundary surface of the optical waveguide at different angles in at least one spatial direction.

3. The device of claim 2, further comprising a surface area illuminated by a light beam on the boundary surface of the optical waveguide increases monotonically over the total illuminated region of the boundary surface.

4. The device of claim 3, wherein the monotonic increase follows a cosine factor.

5. The device of claim 1, the input coupling hologram further comprising an input coupling structure with a location-dependent grating constant.

6. The device of claim 1, the image-generating unit further comprising a microscanner.

7. The device of claim 1, wherein the light source produces a non-collimated light beam, and the input coupling hologram compensates for the lack of collimation of the light beam.

8. The device of claim 1, wherein the light source produces a collimated light beam.

9. The device of claim 8, the light source further comprising a laser.

10. A device for generating a virtual image, having:
at least one light source for producing a collimated light beam;
an image-generating unit having a microscanner for producing an image; and
an optical waveguide for expanding an exit pupil, the optical waveguide having an input coupling hologram with an input coupling structure with a location-dependent grating constant;
wherein, with the image-generating unit in connection with the input coupling hologram, a field-point-dependent aperture for the optical waveguide is implemented in that light beams emanating from the microscanner are incident on the coupling structure at different angles in at least one spatial direction.

11. The device for generating a virtual image of claim 10, wherein the device is part of a vehicle, and generates a virtual image for a driver of the vehicle.
